(19) United States
(12) Patent Application Publication
(10) Pub. No.: US 2026/0136115 A1
(43) Pub. Date: May 14, 2026

(54) RAMP GENERATOR

(71) Applicant: SK hynix Inc., Icheon-si Gyeonggi-do (KR)

(72) Inventors: Jeong Ik CHOI, Icheon-si Gyeonggi-do (KR); Gun Hee YUN, Icheon-si Gyeonggi-do (KR)

(73) Assignee: SK hynix Inc., Icheon-si Gyeonggi-do (KR)

(21) Appl. No.: 19/095,841

(22) Filed: Mar. 31, 2025

(30) Foreign Application Priority Data
Nov. 8, 2024 (KR) 10-2024-0158293

(51) Int. Cl. H04N 25/78; H04N 25/616; H04N 25/709

(52) U.S. Cl. CPC H04N 25/78; H04N 25/616; H04N 25/709

(57) ABSTRACT

A ramp generator for generating a ramp signal from an image sensor is disclosed. The ramp generator includes a bias voltage generator configured to generate a bias voltage, and a plurality of ramp cells configured to generate a ramp signal based on the bias voltage. Each of the plurality of ramp cells includes a local sampling circuit configured to adjust a sampling timing point of the bias voltage.

### CROSS-REFERENCE TO RELATED APPLICATION

The present application claims priority under 35 U.S.C. § 119 (a) to Korean patent application No. 10-2024-0158293, filed on Nov. 8, 2024, in the Korean Intellectual Property Office, which application is incorporated herein by reference in its entirety.

### TECHNICAL FIELD

The technology and implementations disclosed in this patent document generally relate to a ramp generator capable of generating a ramp signal from an image sensor.

### BACKGROUND

Generally, a Complementary Metal Oxide Semiconductor CMOS Image Sensor CIS implemented by a CMOS process has been developed to have lower power consumption, lower costs, and smaller sizes than other competitive products, such that CMOS image sensors CISs have been intensively researched and have rapidly come into widespread use. Specifically, CMOS image sensors CISs have been developed to have higher image quality than other competitive products, such that the application scope of CMOS image sensors CISs has recently been extended to video applications that require higher resolution and higher frame rate as compared to competitive products.

In contrast to a solid state image pickup device, it is necessary for the CMOS image sensor CIS to convert analog signals pixel signals generated from a pixel array into digital signals. In order to convert analog signals into digital signals, the CMOS image sensor CIS has been designed to include a high-resolution Analog-to-Digital Converter ADC therein.

The analog-to-digital converter ADC may perform correlated double sampling about an analog output voltage indicating an output signal of the pixel array, and may store the resultant voltage. In response to a ramp signal generated by the ramp signal generator, the ADC may compare the stored voltage obtained by the correlated double sampling operation with a predetermined reference voltage ramp signal, such that the ADC may provide a comparison signal for generating a digital code.

However, since the ramp signal generator generates the ramp signal based on a power-supply voltage, power noise or noise of the ramp signal generator may be included in the ramp signal and then output. Such noise may cause increased horizontal noise of a CMOS image sensor CIS. Therefore, in order to implement a high-resolution and high-speed CMOS image sensor, a method for efficiently reducing horizontal noise is required.

### SUMMARY

In accordance with an embodiment of the present disclosure, a ramp generator may include: a bias voltage generator configured to generate a bias voltage; and a plurality of ramp cells configured to generate a ramp signal based on the bias voltage. Each of the plurality of ramp cells may include a local sampling circuit configured to adjust a sampling timing point of the bias voltage.

In accordance with another embodiment of the present disclosure, a ramp generator may include: a first ramp cell including a first local sampling circuit configured to sample a bias voltage based on a first control signal, the first ramp cell generating a ramp signal based on a sampling operation of the first local sampling circuit; and a second ramp cell including a second local sampling circuit configured to sample the bias voltage based on a second control signal, the second ramp cell generating the ramp signal based on a sampling operation of the second local sampling circuit. The first control signal and the second control signal may be activated at different timing points.

### BRIEF DESCRIPTION OF THE DRAWINGS

The above and other features and beneficial aspects of the present disclosure will become readily apparent with reference to the following detailed description when considered in conjunction with the accompanying drawings.

FIG. 1 is a block diagram illustrating an example of a ramp generator based on some implementations of the present disclosure.

FIG. 2 is a circuit diagram illustrating an example of a bias voltage generator, shown in FIG. 1, based on some implementations of the present disclosure.

FIG. 3 is a circuit diagram illustrating an example of a ramp signal generator, shown in FIG. 1, based on some implementations of the present disclosure.

FIG. 4 is a circuit diagram illustrating an example of a plurality of ramp cells, shown in FIG. 3, based on some implementations of the present disclosure.

FIG. 5 is a circuit diagram illustrating an example operation of reducing noise by ramp cells, shown in FIG. 4, based on some implementations of the present disclosure.

FIG. 6 is a waveform diagram illustrating example operations of reducing noise by the ramp cells, shown in FIG. 4, based on some implementations of the present disclosure.

FIG. 7 is a block diagram illustrating an example of an image sensing device including the ramp generator, shown in FIG. 1, based on some implementations of the present disclosure.

### DETAILED DESCRIPTION

This patent document provides implementations and examples of a ramp generator capable of generating a ramp signal from an image sensor that may be used in configurations to substantially address one or more technical or engineering issues and to mitigate limitations or disadvantages encountered in some other image sensing devices. Some embodiments of the present disclosure relate to an image sensing device capable of reducing horizontal noise by removing ramp noise. In recognition of the issues above, the ramp generator based on some implementations of the present disclosure can improve noise characteristics of the image sensor by removing horizontal noise.

Reference will now be made in detail to some embodiments of the present disclosure, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

Various embodiments of the present disclosure relate to an image sensing device capable of reducing horizontal noise by removing ramp noise.

It is to be understood that both the foregoing general description and the following detailed description of the present disclosure are illustrative and explanatory and are intended to provide further explanation of the disclosure as claimed.

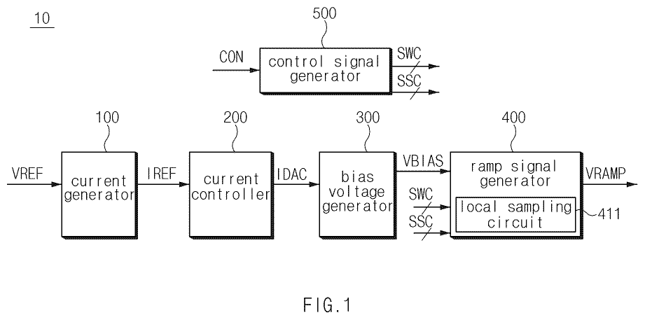

FIG. 1 is a block diagram illustrating an example of a ramp generator based on some implementations of the present disclosure.

Referring to FIG. 1, the ramp generator 10 may generate a ramp signal VRAMP required for an analog-to-digital conversion operation and may supply the ramp signal VRAMP to an analog-to-digital converter (ADC) (to be described later). For example, the ramp generator 10 may be implemented as a current steering digital-to-analog converter (DAC) capable of adjusting a gain of an image sensor by controlling the current.

The ramp generator 10 can include a current generator 100, a current controller 200, a bias voltage generator 300, a ramp signal generator 400, and a control signal generator 500.

Referring to FIG. 1, the current generator 100 may generate a reference current IREF based on a reference voltage VREF. In one example, the current generator 100 may correspond to a circuit that converts an input voltage into a current. For example, the current generator 100 may include an operational amplifier (OP-AMP)-based voltage-to-current converter, a transistor-based voltage-to-current converter, or an integrated circuit (IC)-based voltage-to-current converter, but the types of such converters are not limited thereto.

For example, the reference voltage VREF may be generated by a band gap reference circuit (not shown). The band gap reference circuit may generate a reference voltage VREF having a constant level while substantially avoiding being affected by changes in the manufacturing process, electrical load, time, or ambient temperature.

The current controller 200 may control a value of the reference current IREF that serves as a basis for adjusting the gain of the image sensor. For example, the current controller 200 may receive the reference current IREF from the current generator 100, adjust the gain of the input reference current IREF, and output the current IDAC corresponding to the adjusted gain.

For example, the current controller 200 may include a current steering circuit, a current mirroring circuit, etc. The current steering circuit may be connected to the current generator 100 in a current mirror structure, and a copy ratio of the reference current IREF may be determined by the current steering operation. The current mirror circuit may mirror the current received from the current steering circuit and may provide the current IDAC to the bias voltage generator 300.

The bias voltage generator 300 may generate a bias voltage VBIAS based on the current IDAC. The bias voltage VBIAS may determine a voltage level that serves as a reference for the ramp signal VRAMP. The bias voltage generator 300 may adjust the bias voltage VBIAS to control the average voltage level of the ramp signal VRAMP.

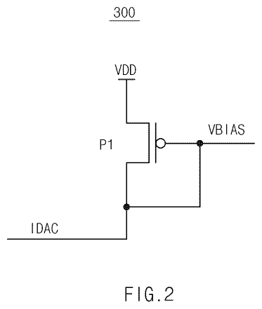

For example, the bias voltage generator 300 may include a resistor, an operational amplifier (OP-AMP), a transistor, or an IC-based current-to-voltage converter, but the type of the converter is not limited thereto. In one example, a part of the bias voltage generator 300 may form a current mirror circuit together with a part of the current controller 200. The detailed configuration of the bias voltage generator 300 will be described later with reference to FIG. 2.

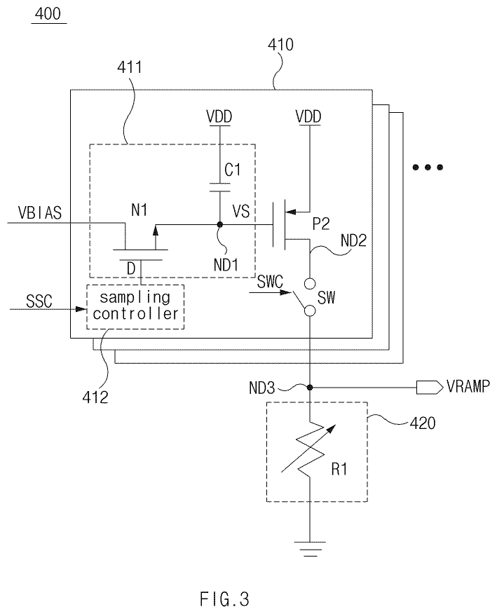

The ramp signal generator 400 may generate the ramp signal VRAMP based on a bias voltage VBIAS, switch control signals SWC, and sampling control signals SSC. The ramp signal generator 400 may control a waveform (e.g., a slope) of the ramp signal VRAMP based on the bias voltage VBIAS and the switch control signals SWC. In addition, the ramp signal generator 400 may reduce noise of the ramp signal VRAMP based on the sampling control signals SSC. The detailed configuration and operation of the ramp signal generator 600 will be described later with reference to FIGS. 3 to 7.

In some implementations, the ramp signal generator 400 may include a local sampling circuit 411. The local sampling circuit 411 may sample the bias voltage VBIAS received from the bias voltage generator 300. The local sampling circuit 411 may control the operation timing points of a plurality of ramp cells (to be described later) included in the ramp signal generator 400 to be different from each other, thereby reducing correlation noise between the ramp cells. Accordingly, the noise of the ramp signal VRAMP generated by the ramp signal generator 400 may be reduced. The detailed configuration and operation of the local sampling circuit 411 will be described later with reference to FIGS. 3 to 7.

The control signal generator 500 may generate switch control signals SWC and sampling control signals SSC that control the operation of the ramp signal generator 400 based on the control signal CON. The control signal CON may be a signal generated by a timing controller (to be described later). In addition, although the control signal controller 500 is illustrated separately in the present embodiment, the control signal generator 500 may be included in the timing controller of the image sensor to be described later. A detailed description of the switch control signals SWC and the sampling control signals SSC generated by the control signal generator 500 will be given later with reference to FIGS. 3 to 7.

FIG. 2 is a circuit diagram illustrating an example of the bias voltage generator 300, shown in FIG. 1, based on some implementations of the present disclosure.

Referring to FIG. 2, the bias voltage generator 300 may convert the current IDAC received from the current controller 200 into a bias voltage VBIAS.

The bias voltage generator 300 may include a transistor P1. For example, the transistor P1 may be a PMOS transistor.

The transistor P1 may be connected between a power-supply voltage VDD input terminal and a current IDAC input terminal. A gate terminal and a drain terminal of the transistor P1 may be commonly connected to each other so that the transistor P1 receives the current IDAC.

FIG. 3 is a circuit diagram illustrating an example of the ramp signal generator 400, shown in FIG. 1, based on some implementations of the present disclosure.

Referring to FIG. 3, the ramp signal generator 400 may include a ramp cell 410 and a load circuit 420.

The ramp cell 410 may generate a ramp signal VRAMP required for an analog-to-digital conversion operation based on the bias voltage VBIAS, the switch control signal SWC, and the sampling control signal SSC.

In some implementations, the ramp cell 410 may be implemented as a plurality of ramp cells so that the plurality of ramp cells shares the load circuit 420. Although the present embodiment discloses that one load circuit 420 is being shared by the plurality of ramp cells 410, other implementations are also possible. For example, the number of load circuits 420 may be more or less than the number of ramp cells 410 or may be the same as the number of ramp cells 410.

Each of the ramp cells 410 may include a transistor P2, a switch SW1, a local sampling circuit 411, and a sampling controller 412.

For example, the transistor P2 may be a PMOS transistor. The transistor P2 may be connected between the power-supply voltage VDD input terminal and the node ND2. The transistor P2 may receive a sampling voltage VS through a gate terminal thereof. The transistor P2 may selectively supply the power-supply voltage VDD to the node ND2 based on the sampling voltage VS. The transistor P2 may operate as a variable current source that adjusts a microcurrent provided to the node ND2 in response to the sampling voltage VS.

The switch SW may be connected between the node ND2 and the node ND3, and the switching operation may be selectively controlled by the switch control signal SWC. When there are multiple ramp cells 410, the number of switches SW connected according to the multiple switch control signals SWC may be adjusted to control the ramp signal VRAMP.

The local sampling circuit 411 may generate the sampling voltage VS by adjusting the sampling timing point of the bias voltage VBIAS based on the sampling control signal SSC. For example, the local sampling circuit 411 may sample the bias voltage VBIAS during a ramping period of the ramp signal VRAMP. In the present embodiment, when the ramp cell 410 is implemented as multiple ramp cells 410, a local sampling circuit 411 may be included in each ramp cell 410, and thus, each sampling circuit included in each ramp cell will hereinafter be referred to as “local sampling circuit” for convenience of description.

The local sampling circuit 411 may include a sampling switch N1 and a sampling capacitor C1.

Here, the sampling switch N1 may be connected between the bias voltage VBIAS input terminal and the node ND1 so that the switching operation is controlled by a control signal D. For example, the sampling switch N1 may be a transistor connected between the bias voltage VBIAS input terminal and the node ND1 so that the control signal D is applied to the gate terminal of the transistor. For example, the sampling switch N1 may be an NMOS transistor. The sampling capacitor C1 may be connected between the power-supply voltage VDD input terminal and the node ND1.

When the sampling switch N1 is turned on, the bias voltage VBIAS may be directly transmitted to the transistor P2. That is, the transistor P2 may receive the bias voltage VBIAS as the sampling voltage VS. On the other hand, when the sampling switch N1 is turned off, a constant sampling voltage VS sampled and maintained by the sampling capacitor C1 may be transmitted to the transistor P2. For example, it is preferable that the sampling switch N1 be controlled within a 1 row time section according to the control signal D received from the sampling controller 412.

As described above, the ramp signal generator 400 according to the present embodiment may include a local sampling circuit 411 in each ramp cell 410 to sample the bias voltage VBIAS applied to the transistor P2 of each ramp cell 410 so that the ramp signal generator 400 blocks ramp noise to be temporally transmitted and thus reduce horizontal noise.

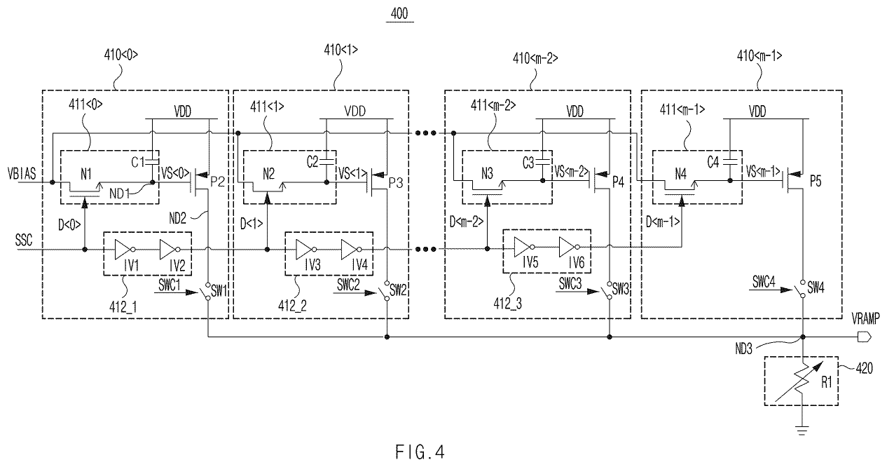

The sampling controller 412 may adjust the operation timing point of the local sampler 411 in each of the ramp cells 410 based on the sampling control signal SSC received from the control signal generator 500. For example, when the ramp cell 410 is implemented as a plurality of ramp cells 410, the operation timing points of each of the local sampling circuits 411 respectively included in the ramp cells 410 may be controlled to be different from one another, resulting in a reduction in correlation noise between the ramp cells 410. A detailed configuration and operation of the sampling controller 412 will be described later with reference to FIG. 4.

The load circuit 420 may control a loading of the ramp signal VRAMP generated by the ramp cells 410. The load circuit 420 may include a variable resistor R1, a resistance value of which can be changed to perform offset adjustment, but the scope of the present disclosure is not limited thereto. The variable resistor R1 may be connected between the node ND3 and the ground voltage terminal so that a resistance level can be adjusted. For example, a resistance level of the variable resistor R1 may be adjusted based on a control signal (not shown) received from the control signal generator 500.

As the resistance of the load circuit 420 decreases, a gap (i.e., a swing width) between a maximum voltage level and a minimum voltage level of the ramp signal VRAMP may decrease. In one example, when the swing width of the ramp signal VRAMP is relatively small, image data corresponding to a relatively large value may be generated for the same pixel signal. In other words, the analog gain may increase. On the other hand, as the resistance of the load circuit 420 increases, the swing width of the ramp signal VRAMP may increase. In one example, when the swing width of the ramp signal VRAMP is relatively large, image data corresponding to a relatively small value may be generated for the same pixel signal. In other words, the analog gain may decrease.

FIG. 4 is a circuit diagram illustrating an example of the plurality of ramp cells, shown in FIG. 3, based on some implementations of the present disclosure.

Referring to FIG. 4, the ramp signal generator 400 according to the present disclosure may include M ramp cells 410<0:m−1>.

For example, the ramp cell 410<0> may include a transistor P2, a switch SW1, a local sampling circuit 411<0>, and a sampling controller 412_1. The sampling controller 412_1 may generate a control signal D<1> by delaying the sampling control signal SSC for a predetermined time. For example, the sampling controller 412_1 may include a plurality of inverters IV1 and IV2 for non-inverting the sampling control signal SSC. The control signal D<0> by which the sampling control signal SSC is bypassed without performing the delay operation by the sampling controller 412_1 may be output to a gate terminal of the sampling switch N1. In addition, the control signal D<1> output from the sampling controller 412_1 may be transmitted to a gate terminal of the sampling switch N2 located at a subsequent stage.

The ramp cell 410<1> may include a transistor P3, a switch SW2, a local sampling circuit 411<1>, and a sampling controller 412_2. The sampling controller 412_2 may generate a control signal D<m−2> by delaying the control signal D<1> for a predetermined time. For example, the sampling controller 412_2 may include a plurality of inverters IV3 and IV4 for non-inverting the control signal D<1>. The control signal D<m−2> output from the sampling controller 412_2 may be transmitted to a gate terminal of the sampling switch N3 located at a subsequent stage.

The ramp cell 410<m−2> may include a transistor P4, a switch SW3, a local sampling circuit 411<m−2>, and a sampling controller 412_3. The sampling controller 412_3 may generate a control signal D<m−1> by delaying the control signal D<m−2> for a predetermined time. For example, the sampling controller 412_3 may include a plurality of inverters IV5 and IV6 for non-inverting the control signal D<m−2>. The control signal D<m−1> output from the sampling controller 412_3 may be transmitted to a gate terminal of the sampling switch N4 located at a subsequent stage.

The ramp cell 410<m−1> may include a transistor P5, a switch SW4, and a local sampling circuit 411<m−1>. When the number of ramp cells is ‘m’, the ramp cell 410<m−1> of the last stage may not include a sampling controller. However, if the number of ramp cells is changed to another number as needed, the ramp cell of the last stage may include a sampling controller. Since the configuration and operation of each of the M ramp cells 410<0:m−1> of FIG. 4 are the same as those of FIG. 3, a detailed description of the same connection structures and operations will herein be omitted for brevity.

The M ramp cells 410<0:m−1> may perform sampling operations at different timing points according to control signals D<0:m−1> obtained when the sampling control signal SSC is delayed by different times. That is, the local sampling circuit 411<0> may be operated by the sampling control signal SSC (i.e., the control signal D<0> having no delay time). In addition, since the local sampling circuit 411<1> is operated by the control signal D<1> delayed by the sampling controller 412_1, the local sampling circuit 411<1> may operate later than the local sampling circuit 411<0>. Since the local sampling circuit 411<m−2> is operated by the control signal D<m−2> delayed by the sampling controller 412_2, the local sampling circuit 411<m−2> may operate later than the local sampling circuit 411<1>. Since the local sampling circuit 411<m−1> is operated by the control signal D<m−1> delayed by the sampling controller 412_3, the local sampling circuit 411<m−1> may operate later than the local sampling circuit 411<m−2>.

The present embodiment has disclosed an example case in which M ramp cells 410<0:m−1> sequentially perform sampling operations with different delay times, but the scope of the present disclosure is not limited thereto. If necessary, M ramp cells 410<0: m−1> may selectively perform sampling operations depending on the structures of the sampling controllers 412_1˜412_3 and adjustment of the delay times of the sampling controllers 412_1˜412_3.

When M ramp cells 410<0:m−1> share one local sampling circuit, the M ramp cells 410<0:m−1> may perform sampling operations based on one sampling voltage VS. In this case, correlation noise of the M ramp cells 410<0:m−1> may increase.

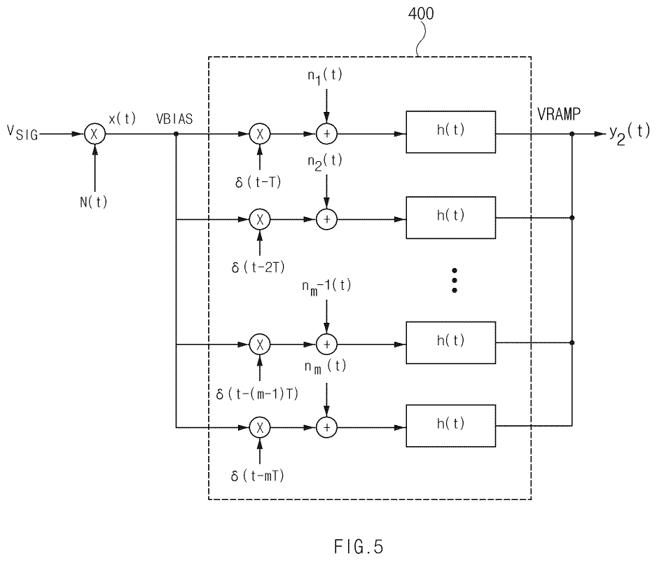

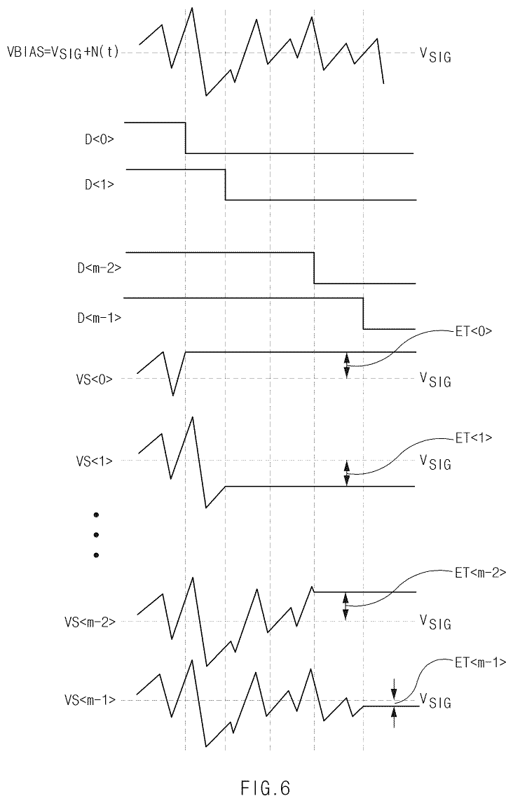

Therefore, according to the present disclosure, a separate local sampling circuit 411<0:m−1> may be included in each of the M ramp cells 410<0:m−1>, so that the sampling operation can be performed individually in each ramp cell 410<0:m−1>. Accordingly, according to the present disclosure, the M ramp cells 410<0:m−1> may perform sampling operations at different timing points so that correlation noise between the ramp cells can be reduced. A detailed description of such operation will be given later with reference to FIGS. 5 and 6.

FIG. 5 is a circuit diagram illustrating an example operation of reducing noise by the ramp cells shown in FIG. 4 based on some implementations of the present disclosure. FIG. 6 is a waveform diagram illustrating example operations of reducing noise by the ramp cells shown in FIG. 4 based on some implementations of the present disclosure.

Referring to FIGS. 5 and 6, a voltage received from the bias voltage generator 300 will be defined as ‘VSIG’, and noise received from the bias voltage generator 300 will be defined as ‘N (t)’. Then, the bias voltage VBIAS may be denoted by ‘x(t)’ corresponding to the sum of the voltage VSIG and the noise N(t).

The bias voltage VBIAS may be input to the ramp signal generator 400. M local sampling circuits 411<0:m−1> may perform the sampling operation based on M control signals D<0:m−1>. In FIG. 5, since the M control signals D<0:m−1> are activated at different timing points, the M control signals D<0:m−1> may be defined as δ(t−T), δ(t−2T), δ(t−(m−1)T), and δ(t−mT), respectively. Here, “T” may represent a magnification of the delay time.

For example, as shown in FIG. 6, M control signals D<0:m−1> may be activated by transitioning to a logic low level at different timing points. The control signal D<0> may be activated and the control signal D<1> may be activated after a predetermined time. The control signal D<1> may be activated and the control signal D<2> may be activated after a predetermined time. The control signal D<2> may be activated and the control signal D<m−2> may be activated after a predetermined time. The control signal D<m−2> may be activated and the control signal D<m−1> may be activated after a predetermined time.

When the M control signals D<0:m−1> are sequentially activated, the sampling transistors N1˜N4 may be sequentially turned off. That is, the turn-off timing points of the sampling transistors N1˜N4 may be controlled by the M control signals D<0:m−1> to be different.

When the sampling operations are sequentially performed by the sampling capacitors C1˜C4, the sampling voltages VS<0:m−1> may maintain the sampling voltage level. When the sampling operation is performed, not only the bias voltage VBIAS for generating the ramp signal VRAMP but also noise can be sampled. The noises of the sampling voltages VS<0:m−1> sampled and generated by the voltage local sampling circuits 411<0:m−1> may be defined as n1(t), n2(t), nm−1(t), and nm(t), respectively.

The noise (i.e., error term) sampled in the ramp cell 410<0> may have a value of ET<0>. The noise sampled in the ramp cell 410<1> may have a value of ET<1>. The noise sampled in the ramp cell 410<m−2> may have a value of ET<m−2>. The noise sampled in the ramp cell 410<m−1> may have a value of ET<m−1>.

In addition, each of the voltage values generated by the M ramp cells 410<0:m−1> may be denoted by ‘h(t)’. A voltage value of the load circuit 410 is added to the h (t) value output from each ramp cell 410<0:m−1>, so that the ramp signal VRAMP has a value of y2 (t).

Based on the above-described operations, the operation of reducing noise by the ramp signal generator 400 may be represented by Equation 1 below.

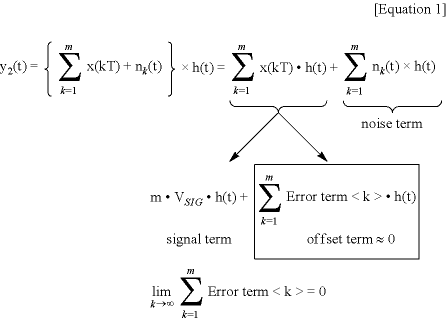

The noise generated from the M ramp cells 410<0:m−1> may have a value of ET<0:m−1>. However, noise of the ramp signal generator 400 may be generated and transferred to a destination when the current generator 100 generates a reference voltage and/or when the current controller 200 adjusts a gain so that this noise corresponds to thermal noise (i.e., white noise). In the present disclosure, the noise of the ramp signal VRAMP may be reduced by spreading a noise offset of each ramp cell 410<0:m−1> to remove the correlation noise. Therefore, as can be seen from Equation 1, the noise average value may converge on zero “0” as the sampling operation is continuously performed.

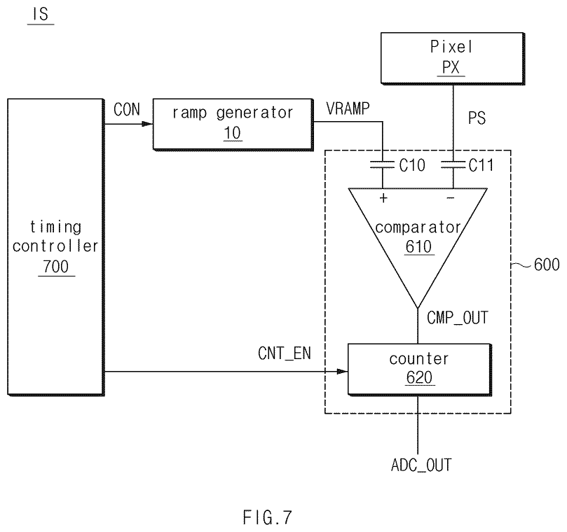

FIG. 7 is a block diagram illustrating an example of an image sensing device IS including the ramp generator 10, shown in FIG. 1, based on some implementations of the present disclosure.

Referring to FIG. 7, the image sensing device IS may include a ramp generator 10, a pixel PX, an analog-to-digital converter ADC 600, and a timing controller 700.

The image sensing device IS shown in FIG. 7 may include the ramp generator 10 described in the embodiments of FIGS. 1 to 6 described above. The ramp generator 10 may generate a ramp signal VRAMP necessary for the analog-to-digital conversion operation of the ADC 600 according to a control signal CON received from the timing controller 700 and may supply the ramp signal VRAMP to the ADC 600.

The pixel array may include a plurality of pixels PXs arranged in rows and columns. In one example, the plurality of pixels PXs can be arranged in a two-dimensional (2D) pixel array including rows and columns. In another example, the plurality of pixels PXs can be arranged in a three-dimensional (3D) pixel array. The plurality of pixels PXs may convert an optical signal into an electrical signal on a pixel basis or a pixel group basis and may output a pixel signal PS. Here, the pixels PXs in a pixel group may share at least certain internal circuitry. The pixel array may receive driving signals RCON, including a row line selection signal, a pixel reset signal, a transfer signal, etc. from the row driver not shown. Upon receiving the driving signals, corresponding imaging pixels in the pixel array may be activated to perform the operations corresponding to the row line selection signal, the pixel reset signal, and the transfer signal.

The ADC 600 may sequentially sample and hold voltage levels of the reference signal and the image signal, which are provided to each of a plurality of column lines from the pixel array. The ADC 600 may receive the ramp signal VRAMP from the ramp generator 10, receive the pixel signal PS from the pixel PX, and generate and output ADC data ADC_OUT based on the ramp signal VRAMP and the pixel signal PS. In some implementations, the ADC 600 may be implemented as a ramp-compare type ADC that uses the ramp signal VRAMP of the ramp generator 10.

In some implementations, the ADC 600 may include a first capacitor C10, a second capacitor C11, a comparator 610, and a counter 620.

The first capacitor C10 may receive the ramp signal VRAMP, and may transmit the received ramp signal VRAMP to the comparator 610. The second capacitor C11 may receive the pixel signal PS, and may transmit the received pixel signal PS to the comparator 610.

The comparator 610 may compare the ramp signal VRAMP and the pixel signal PS with each other, generate comparison data CMP_OUT based on the comparison result, and transmit the comparison data CMP_OUT to the counter 620. In some implementations, when the ramp signal VRAMP is greater than the pixel signal PS, the comparator 610 may generate comparison data CMP_OUT of a logic high level. In addition, when the ramp signal VRAMP is less than the pixel signal PS, the comparator 610 may generate comparison data CMP_OUT of a logic low level. That is, the comparison data CMP_OUT may represent the relationship between the magnitude of the ramp signal VRAMP and the magnitude of the pixel signal PS.

In some implementations, the counter 620 may be activated in response to a counter enable signal CNT_EN received from the timing controller 700. The counter 620 may perform a counting operation until the ramp signal VRAMP matches the analog pixel signal PS. Then, the activated counter 620 may perform counting in response to the comparison data CMP_OUT of the logic high level and may output the counting result as ADC data ADC_OUT.

The timing controller 700 may control at least one of the ramp generator 10 and the ADC 600. The timing controller 700 may generate a control signal CON that controls the operation of the ramp generator 10. The timing controller 700 may generate a counter enable signal CNT_EN that controls the operation of the counter 620.

As is apparent from the above description, the ramp generator based on some implementations of the present disclosure can improve noise characteristics of the image sensor by removing horizontal noise.

The embodiments of the present disclosure may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. A ramp generator comprising:
a ramp generator including a bias voltage generator configured to generate a bias voltage; and
a plurality of ramp cells configured to generate a ramp signal based on the bias voltage,
wherein each of the plurality of ramp cells includes:
a local sampling circuit configured to adjust a sampling timing point of the bias voltage.

2. The ramp generator according to claim 1, wherein the local sampling circuit includes:
a sampling switch connected between an input terminal of the bias voltage and a first node so that a switching operation thereof is controlled by a control signal; and
a sampling capacitor connected between a power-supply voltage input terminal and the first node.

3. The ramp generator according to claim 2, wherein the local sampling circuit is configured such that:
a sampling voltage is controlled in response to the bias voltage when the sampling switch is turned on; and
the sampling voltage is controlled by the sampling capacitor when the sampling switch is turned off.

4. The ramp generator according to claim 1, further comprising:
a sampling controller configured to, based on a sampling control signal, generate a plurality of control signals, each corresponding to a respective local sampling circuit included in the plurality of ramp cell and each corresponding to a different sampling operation timing point.

5. The ramp generator according to claim 4, wherein the sampling controller includes:
a plurality of inverters configured to respectively control delay times of the plurality of control signals.

6. The ramp generator according to claim 1, wherein each of the plurality of ramp cells includes:
a transistor configured to selectively supply a power-supply voltage to a second node based on an output signal of the local sampling circuit; and
a switch connected between the second node and an output terminal of the ramp signal so that a switching operation thereof is controlled by a switch control signal.

7. The ramp generator according to claim 1, further comprising:
a load circuit configured to control a loading of the ramp signal.

8. The ramp generator according to claim 7, wherein:
the load circuit is shared by the plurality of ramp cells.

9. The ramp generator according to claim 1, wherein:
the plurality of ramp cells is activated at different timing points by a local sampling circuits, respectively.

10. The ramp generator according to claim 1, wherein:
the plurality of ramp cells is sequentially activated by local sampling circuits, respectively.

11. The ramp generator according to claim 1, wherein:
the plurality of ramp cells is selectively activated by local sampling circuits, respectively.

12. A ramp generator comprising:
a first ramp cell including a first local sampling circuit configured to sample a bias voltage based on a first control signal, the first ramp cell generating a ramp signal based on a sampling operation of the first local sampling circuit; and
a second ramp cell including a second local sampling circuit configured to sample the bias voltage based on a second control signal, the second ramp cell generating the ramp signal based on a sampling operation of the second local sampling circuit,
wherein the first control signal and the second control signal are activated at different timing points.

13. The ramp generator according to claim 12, further comprising:
a sampling controller configured to generate the first control signal and the second control signal based on a sampling control signal.

14. The ramp generator according to claim 12, wherein:
when a predetermined time elapses after activation of the first control signal, a second control signal is activated.

15. The ramp generator according to claim 12, wherein each of the first local sampling circuit and the second local sampling circuit includes:
a sampling switch connected between an input terminal of the bias voltage and a first node so that a switching operation thereof is controlled by a control signal; and
a sampling capacitor connected between a power-supply voltage input terminal and the first node.

16. The ramp generator according to claim 15, wherein each of the first local sampling circuit and the second local sampling circuit is configured such that:
a sampling voltage is controlled in response to the bias voltage when the sampling switch is turned on; and
the sampling voltage is controlled by the sampling capacitor when the sampling switch is turned off.

17. The ramp generator according to claim 12, wherein each of the first ramp cell and the second ramp cell includes:
a transistor configured to selectively supply a power-supply voltage to a second node based on an output signal of the local sampling circuit; and
a switch connected between the second node and an output terminal of the ramp signal so that a switching operation thereof is controlled by a switch control signal.

18. The ramp generator according to claim 12, further comprising:
a load circuit configured to control a loading of the ramp signal.

19. The ramp generator according to claim 18, wherein:
the load circuit is shared by the first ramp cell and the second ramp cell.

20. The ramp generator according to claim 12, further comprising:
a bias voltage generator configured to generate the bias voltage.
